(19) United States
(12) Patent Application Publication
(10) Pub. No.: US 2019/0087070 A1
(43) Pub. Date: Mar. 21, 2019

(54) DISPLAY METHOD, ELECTRONIC DEVICE, AND STORAGE MEDIUM

(71) Applicant: Lenovo (Beijing) Co., Ltd., Beijing (CN)

(72) Inventors: Jiahui PAN, Beijing (CN); Wei ZHANG, Beijing (CN)

(21) Appl. No.: 15/995,502

(22) Filed: Jun. 1, 2018

(30) Foreign Application Priority Data
Sep. 20, 2017 (CN) 201710858575.0

(51) Int. Cl. G06F 3/0481; G06F 3/0484; H04L 12/58; G06F 9/451

(52) U.S. Cl. CPC G06F 3/04817; G06F 9/451; H04L 51/24; G06F 3/0484

(57) ABSTRACT

A display method, an electronic device, and a non-transitory computer-readable storage medium are provided. The display method includes obtaining quantity information of unread notification messages received by the electronic device. The method also includes displaying a prompt identifier in a prompt area of a notification bar of a display screen of the electronic device based on the quantity information of the unread notification messages. The prompt identifier displayed in the prompt area of the notification bar is different in response to a different quantity of the unread notification messages.

### CROSS-REFERENCES TO RELATED APPLICATIONS

This application claims the priority of Chinese patent application No. 201710858575.0, filed on Sep. 20, 2017, the entirety of which is incorporated herein by reference.

### FIELD OF THE DISCLOSURE

The present disclosure generally relates to the field of display technology and, more particularly, relates to a display method, an electronic device, and a storage medium.

### BACKGROUND

With rapid development of information technology, more and more applications are installed on an electronic device. Various applications often push prompt information to the user, and the prompt information is usually displayed in a notification bar of the electronic device to remind the user. However, the notification bar of the electronic device often has a limited prompt area, and the entire prompt information cannot be displayed in detail in the notification bar.

The disclosed display method and electronic device are directed to solve one or more problems set forth above and other problems.

### BRIEF SUMMARY OF THE DISCLOSURE

One aspect of the present disclosure includes a display method. The method includes obtaining quantity information of unread notification messages received by an electronic device. The method also includes displaying a prompt identifier in a prompt area of a notification bar of a display screen of the electronic device based on the quantity information of the unread notification messages. The prompt identifier displayed in the prompt area of the notification bar is different in response to a different quantity of the unread notification messages.

Another aspect of the present disclosure includes an electronic device. The electronic device includes a display screen and a processor coupled with the display screen. The processor is configured to obtain quantity information of unread notification messages received by the electronic device. The processor is also configured to display a prompt identifier in a prompt area of the notification bar of the display screen based on the quantity information of the unread notification messages. The prompt identifier displayed in the prompt area of the notification bar of the display screen is different in response to a different quantity of the unread notification messages.

Another aspect of the present disclosure includes a non-transitory computer-readable storage medium. The non-transitory computer-readable storage medium has computer-executable instructions stored thereon. When being executed, the computer-executable instructions cause a processor to perform a display method. The display method includes obtaining quantity information of unread notification messages received by an electronic device. The display method also includes displaying a prompt identifier in a prompt area of a notification bar of a display screen of the electronic device based on the quantity information of the unread notification messages. The prompt identifier displayed in the prompt area of the notification bar is different in response to a different quantity of the unread notification messages.

Other aspects of the present disclosure can be understood by those skilled in the art in light of the description, the claims, and the drawings of the present disclosure.

### BRIEF DESCRIPTION OF THE DRAWINGS

To more clearly illustrate the embodiments of the present disclosure, the drawings will be briefly described below. The drawings in the following description are certain embodiments of the present disclosure, and other drawings may be obtained by a person of ordinary skill in the art in view of the drawings provided without creative efforts.

FIGS. 1A-1B illustrate examples of application scenarios of a display method and an electronic device consistent with some embodiments of the present disclosure;

FIG. 2 illustrates a flow chart of an example of a display method consistent with some embodiments of the present disclosure;

FIG. 3A illustrates a flow chart of an example of a method for displaying prompt identifier based on the quantity of unread notification messages consistent with some embodiments of the present disclosure;

FIGS. 3B-3F illustrate schematic diagrams of examples of prompt identifiers consistent with some embodiments of the present disclosure;

FIG. 4 illustrates a flow chart of another example of a method for displaying prompt identifier based on the quantity of unread notification messages consistent with some embodiments of the present disclosure;

FIG. 5A illustrates an example of a method for updating prompt identifier consistent with some embodiments of the present disclosure;

FIGS. 5B-5I illustrate schematic diagrams of examples of updated prompt identifiers consistent with some embodiments of the present disclosure; and

FIG. 6 illustrates a schematic diagram of an example of an electronic device consistent with some embodiments of the present disclosure.

### DETAILED DESCRIPTION

Reference will now be made in detail to various embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on some embodiments, persons of ordinary skill in the art may derive other embodiments consistent with the present disclosure, all of which are within the scope of the present disclosure.

The disclosed embodiments in the present disclosure are merely examples for illustrating the general principles of the disclosure. Any equivalent or modification thereof, without departing from the spirit and principle of the present disclosure, falls within the true scope of the present disclosure.

Moreover, the terms “include” and “contain” and their derivatives mean inclusion but not limitation. The term “or” is inclusive and means “and/or”. The term “and/or” may be used to indicate that two associated objects may have three types of relations. For example, “A and/or B” may represent three situations: A exists, A and B coexist, and B exists.

In addition, the term “at least one of A, B and C” and their derivatives mean inclusion but not limitation. For example, the term “at least one system of A, B and C” may include but not be limited to the following situations: A exists, B exists, C exists, A and B coexist, A and C coexist, B and C coexist, and A, B and C coexist.

The method, apparatus, components and units in various embodiments of the present disclosure may be realized through a computing-capable electronic device that executes software containing computer instructions. The system may include a storage device to realize the various types of storage described above. The computing-capable electronic device may include but is not limited to a device capable of executing computer instructions, such as a general purpose processor, a digital signal processor, a dedicated processor, and a reconfigurable processor, etc. Execution of such instructions may cause the electronic device to be configured to perform the above-disclosed respective operations. The above devices and/or units may be realized in one electronic device or in different electronic devices. The software may be stored in the computer-readable storage medium. The computer-readable storage medium may store one or more programs (software units). The one or more programs may include instructions that enable the electronic device to perform the disclosed methods in the present disclosure in response to executing the instructions by one or more processors in the electronic device.

In some embodiments, the software may be stored in a form of volatile memory or non-volatile memory device, such as a memory device like ROM, no matter whether it is erasable or rewritable. In other embodiments, the software may be stored in a form of memory (e.g., RAM, memory chip, device, or integrated circuit). In certain embodiments, the software may be stored in an optically readable medium or a magnetically readable medium, such as a CD, a DVD, a magnetic disk, or a magnetic tape, etc. The memory device and the memory medium are examples of machine-readable memory devices that are suitable for storing one or more programs. The one or more programs may include instructions that enable implementation of disclosed embodiments in response to being executed. The present disclosure provides the program and a machine-readable memory device that stores the program. The program may include codes of the apparatus or method for implementing any one of the claims in the present disclosure. In addition, the program may be electronically transmitted via any medium, such as communication signal carried over a wire connection or a wireless connection, and may be appropriately included in various embodiments of the present disclosure.

The present disclosure provides a display method and an electronic device capable of executing the disclosed method. The method includes obtaining quantity information of unread notification messages received by the electronic device. The method also includes displaying a prompt identifier in a prompt area of the notification bar of a display screen of the electronic device based on the quantity information of the unread notification messages. The prompt identifier displayed in the prompt area of the notification bar is different in response to a different quantity of the unread notification messages. The prompt area is neither extended due to an increase of the quantity of the unread notification messages, nor narrowed due to a decrease of the quantity of the unread notification messages. That is, an occupied area of the prompt area of the notification bar does not change, while the prompt identifier of the unread notification messages in the prompt area changes.

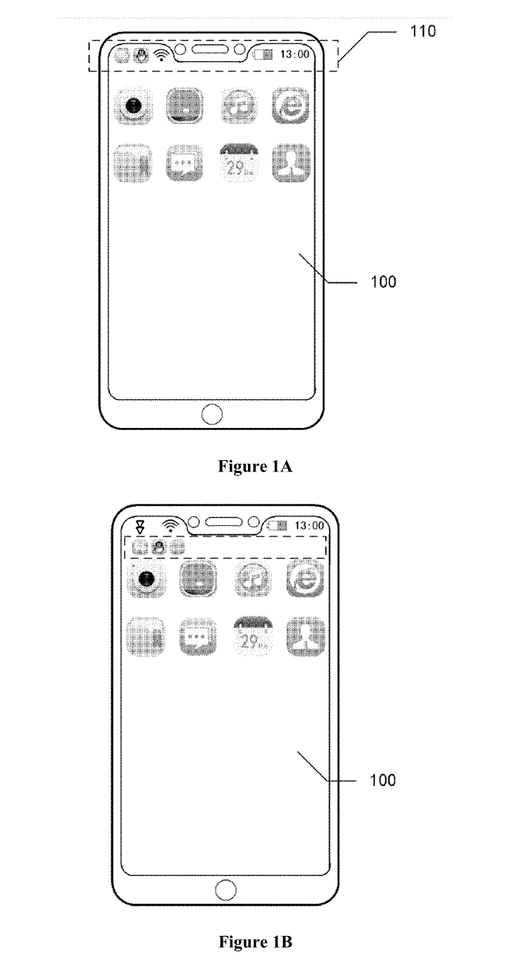

FIGS. 1A-1B illustrate examples of application scenarios of a display method and an electronic device consistent with some embodiments of the present disclosure. Referring to FIG. 1A, an electronic device 100 may include a notification bar 110. In some embodiments, the notification bar 110 may be divided into a status area and/or a prompt area. The status area may display status information, and the status information may include time information (e.g., 13:00), power information (e.g., 50%), signal strength information, and network information (e.g., 3G, 4G or WiFi, etc.), etc. The prompt area may display a prompt identifier of prompt information, and the prompt information may include notification messages pushed by respective applications in the electronic device 100. For example, the prompt identifier may be a “WeChat” icon in response to a notification message pushed by a “WeChat” server. The prompt identifier may be a “QQ” icon in response to a notification message pushed by a “QQ” server. The prompt identifier corresponding to an unread notification message may be displayed in the prompt area of the notification bar.

In some embodiments, the electronic device 100 may be a cell phone, a tablet computer, a laptop, or a desktop computer, etc. The notification bar 110 may be displayed on an upper end, a lower end, a left side or a right side of a display unit of the electronic device 100. The display position of the notification bar 110 is not limited by the present disclosure, and may be determined according to various application scenarios. Referring to FIG. 1A, a display screen of the electronic device may be a full display screen, which may occupy most area of an upper surface of the electronic device. Accordingly, the user may have a visual feeling that the entire upper surface of the electronic devices is the display output area of the display screen.

In some embodiments, the display area of the notification bar 110 may often be limited. In some embodiments, referring to FIG. 1A, in response to the notification bar 110 being displayed on the upper end of the display unit of the electronic device, due to setting of hardware (e.g., an earpiece and a front camera) of the electronic device 100, the notification bar 110 may be separately displayed on the left side and right side of the upper end of the display unit. Therefore, the display area of the notification bar 110 may be significantly reduced. Accordingly, the display area of the notification bar may be insufficient in response to displaying a plurality of notification messages.

The present disclosure provides a display method, where prompt identifier displayed in the prompt area of the notification bar may be different in response to a different quantity of unread notification messages. In some embodiments, referring to FIG. 1B, in response to the quantity of the unread notification messages being greater than a preset threshold, a specific icon identifier may be displayed in the prompt area of the notification bar. The specific icon identifier may be used to indicate currently more unread notification messages. The specific icon identifier may be, for example, a downward arrow (↓), or two downward triangles as shown in FIG. 1B, etc. The specific icon identifier may be used to notify the user that the electronic device currently has a plurality of unread notification messages. The specific icon identifier may be displayed in the prompt area of the notification bar.

In response to the quantity of unread notification messages being less than or equal to the preset threshold, an icon identifier of an application corresponding to unread notification message may be displayed in the notification bar. In other embodiments, in response to the quantity of unread notification messages being greater than the preset threshold, a numeric identifier consistent with quantity information of unread notification messages may be displayed in the prompt area of the notification bar. The user may be notified that the electronic device currently has a plurality of unread notification messages.

Referring to FIG. 1A and 1B, in some embodiments, the preset threshold may be two. In some embodiments corresponding to FIG. 1A, the quantity of current unread notification messages may be two. The applications corresponding to the two unread notification messages may be determined, respectively, and the icon identifiers of the applications may be displayed in the prompt area of the notification bar. In some embodiments corresponding to FIG. 1B, the quantity of current unread notification messages may be three. The specific icon identifier (e.g., two downward triangles) may be directly displayed in the prompt area of the notification bar, and the specific icon may be used to notify the user with currently more unread notification messages.

A menu page may be displayed by an operation performed on the notification bar to show more contents related to the notification bar. For example, the menu page may be displayed in response to detecting an operation of pulling down the notification bar. The icon identifiers of applications respectively corresponding to the three unread notification messages may be displayed in a page area closest to the notification bar (e.g., a dashed border area in FIG. 1B) in the menu page. In some embodiments, in response to the operation of pulling down the notification bar starting from the prompt area of the notification bar, the icon identifiers of applications respectively corresponding to the three unread notification messages may be displayed in the page area closest to the notification bar (e.g., the dashed border area in FIG. 1B) in the menu page. In other embodiments, in response to the operation of pulling down the notification bar starting from an area other than the prompt area of the notification bar, the page area closest to the notification bar in the menu page may not display the icon identifiers of applications respectively corresponding to the three unread notification messages, while may display other contents related to the notification bar.

In some embodiments, during a process of activating the display screen, the quantity of unread notification messages may be changed (e.g., the quantity of unread notification messages increases or decreases), for example, the quantity of unread notification messages may be changed from not satisfying the preset threshold to satisfying the preset threshold. Accordingly, the icon identifiers of applications may be replaced with the specific icon identifier, which may occupy less display area of the notification bar. For example, referring to FIGS. 1A-1B as the process of activating the display screen for illustrative purposes, in response to a change in the quantity of unread notification messages, the identifier(s) in the prompt area may be changed from the icon identifiers of two applications to the specific icon identifier (e.g., two downward triangles). Further, the preset threshold in some embodiments may be configured as one, or any other suitable value, which is not limited by the present disclosure.

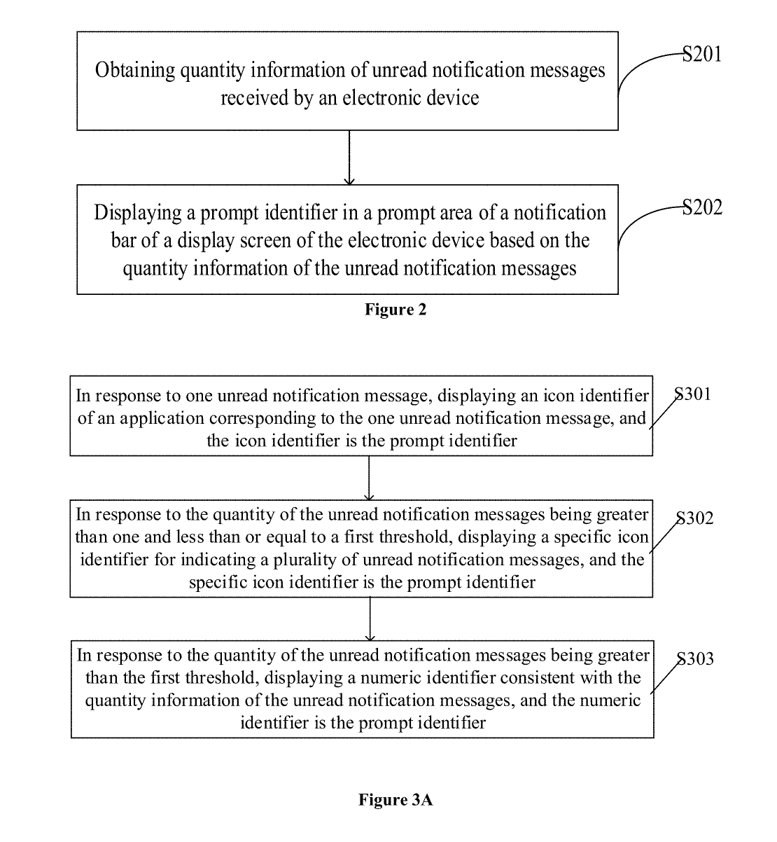

Referring to FIGS. 2-4, the disclosed display method is described as follows in combination with the application scenario illustrated in FIG. 1. The application scenario illustrated in FIG. 1 is merely shown to facilitate understanding of the spirit and principles of the present disclosure, and is not limited by the present disclosure. The disclosed embodiments may be applied to any suitable application scenario(s).

FIG. 2 illustrates a flow chart of an example of a display method consistent with some embodiments of the present disclosure. Referring to FIG. 2, the display method may include the following.

In S201: Obtaining quantity information of unread notification messages received by the electronic device.

In some embodiments, the quantity information of unread notification messages may be obtained in response to the display screen of the electronic device changing from not displaying the notification bar to displaying the notification bar. In other embodiments, the quantity information of unread notification messages may be obtained in response to the electronic device entering a display state (the display contents include the notification bar) from a black-screen state (nothing is displayed).

In some embodiments, an unread notification message may be, for example, a notification message that has not been operated, a notification message that the corresponding content of the notification message has not been read by entering a corresponding application through the notification message, or a notification message that the corresponding content of the notification message has not been read by directly entering a corresponding application. The quantity information of unread notification messages may be the quantity of unread notification messages. For example, there are two unread notification messages in “WeChat” and one unread notification message in “Weibel”, accordingly, the quantity of unread notification messages may be three.

In S202: Displaying the prompt identifier in the prompt area of the notification bar of the display screen of the electronic device based on the quantity information of the unread notification messages. The prompt identifier displayed in the prompt area of the notification bar may be different in response to a different quantity of the unread notification messages.

In some embodiments, the notification bar of the electronic device may include the prompt area, and the prompt area may be configured to display the prompt identifier of unread notification messages. The notification bar may also include other areas, e.g., the status area, etc. The status area may display status information, and the status information may include time information (e.g., 13:00), power information (e.g., 50%), signal strength information, and network information (e.g., 3G, 4G, or WiFi, etc.), etc. In some embodiments, referring to FIG. 1A, in response to the notification bar being displayed at the upper end of the electronic device, the prompt area may be, for example, a partial area on the left side of the notification bar 110.

In some embodiments, the prompt area of the notification bar may display one or two prompt identifiers. In some embodiments, one prompt identifier may be displayed in the prompt area in response to the prompt area of the notification bar including a display area of one prompt identifier. In other embodiments, the prompt area of the notification bar may include a first prompt area and a second prompt area. The first prompt area and the second prompt area may display two same or different prompt identifiers, respectively. In some embodiments, in response to the prompt area including the first prompt area and the second prompt area, the first prompt area and the second prompt area may have a same or different size. For example, the first prompt area may have a smaller size than the second prompt area.

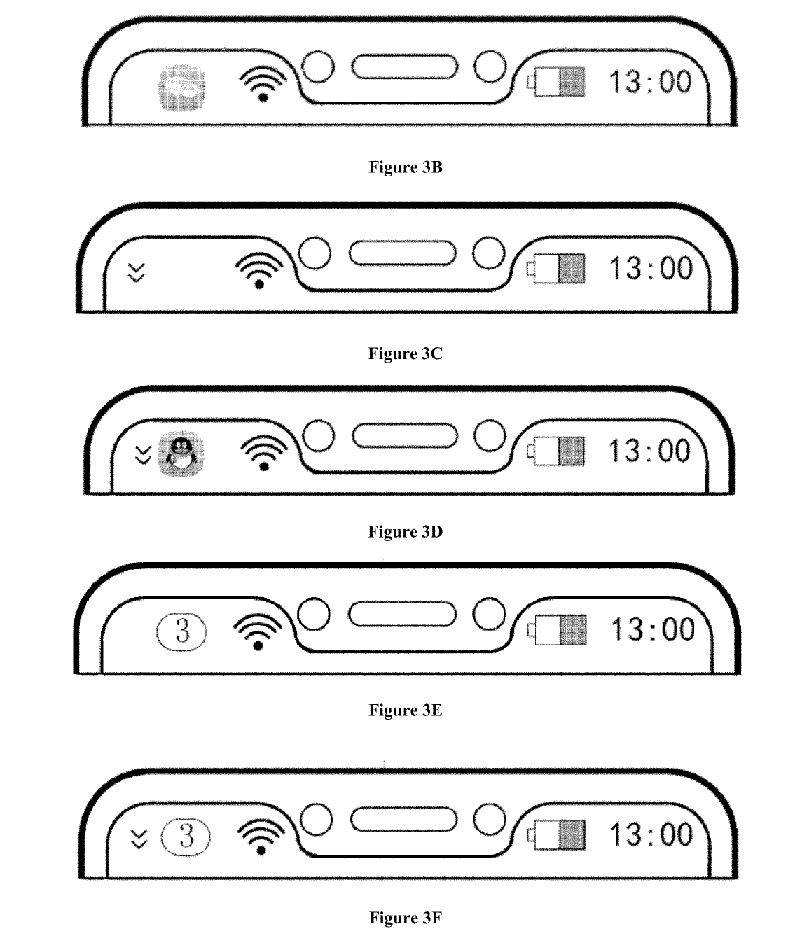

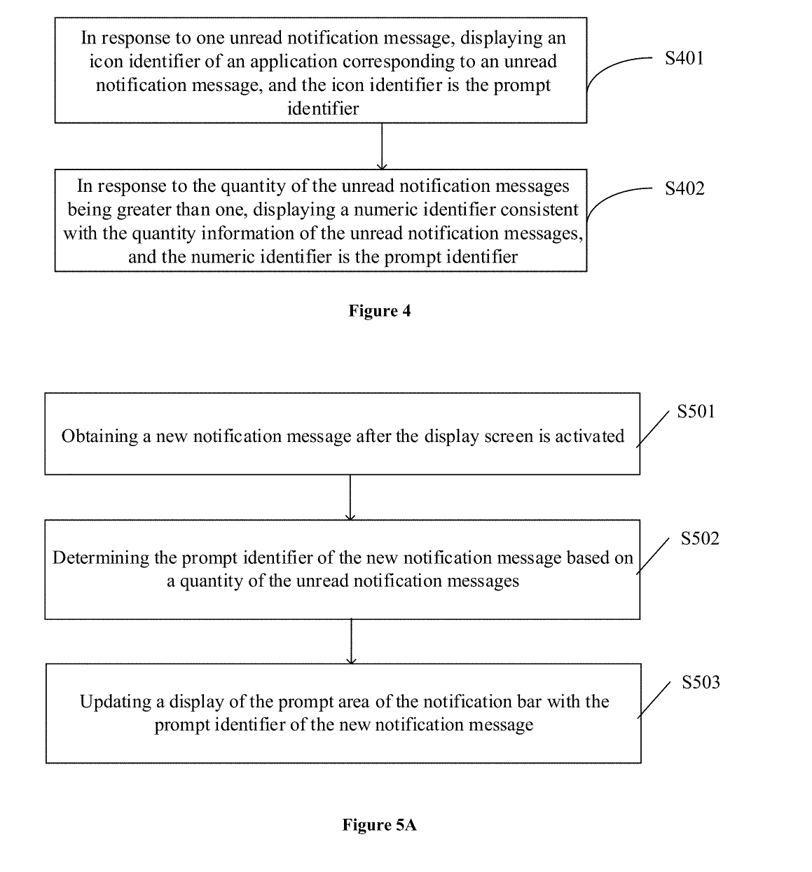

In some embodiments, the prompt identifiers displayed in the prompt area of the notification bar may be different in response to a different quantity of the unread notification messages. For example, the display method may include a method for displaying the prompt identifier(s) as shown in FIGS. 3A-3F, or may include a method for displaying the prompt identifier(s) as shown in FIG. 4.

Referring to FIGS. 3A-3F, the method for displaying the prompt identifier(s) in the prompt area of the notification bar based on the quantity information of the unread notification messages in S202 in FIG. 2 is described in detail as follows.

FIG. 3A illustrates a flow chart of an example of a method for displaying the prompt identifier(s) based on the quantity of the unread notification messages consistent with some embodiments of the present disclosure. Referring to FIG. 3A, the method may include the following.

In S301: In response to one unread notification message, displaying an icon identifier of an application corresponding to the one unread notification message, and the icon identifier may be the prompt identifier.

In some embodiments, there is one unread notification message in response to the quantity of unread notification messages being one. Accordingly, the corresponding application may be determined based on the unread notification messages, and the icon identifier of the application as the prompt identifier may be displayed in the prompt area of the notification bar.

In some embodiments, as shown in FIG. 3B, in response to the one unread notification message and the one unread notification message being a notification message pushed by a “WeChat” server, an icon identifier of the application “WeChat” corresponding to the unread notification message may be obtained. Then, the icon identifier of “WeChat” as the prompt identifier may be displayed in the prompt area of the notification bar to prompt the user with an unread notification message from the “WeChat”.

In some embodiments, in response to the prompt area of the notification bar including one display area for the prompt identifier, the icon identifier of the application may be displayed in the one display area. In response to the prompt area of the notification bar including two display areas for the prompt identifier, the icon identifier of the application may be displayed in a larger display area (e.g., the second prompt area).

In S302: In response to the quantity of the unread notification messages being greater than one and less than or equal to a first threshold, displaying the specific icon identifier, and the specific icon identifier may be the prompt identifier. The specific icon identifier may be used to indicate a plurality of unread notification messages.

In some embodiments, in response to the quantity of unread notification messages being greater than one and less than or equal to the first threshold, there are currently more unread notification messages. Accordingly, the specific icon identifier may be directly displayed in the prompt area of the notification bar. The specific icon may be used to notify the user with currently more unread notification messages.

In some embodiments, the specific icon identifier may be, for example, a downward arrow ↓, two downward triangles as shown in FIG. 1B, or two downward pointing arrows as shown in FIG. 3C, etc. The specific shape of the specific icon identifier is not limited by the present disclosure and may be determined according to various application scenarios.

In some embodiments, as shown in FIG. 3C, in response to the quantity of the unread notification messages being greater than one and less than or equal to the first threshold, the specific icon identifier may be displayed in the prompt area of the notification bar to notify the user that there are more unread notification messages. In some embodiments, the first threshold may be, for example, two. In some embodiments, in response to the quantity of the unread notification messages being two, the specific icon identifier as shown in FIG. 3C may be displayed in the prompt area of the notification bar.

In some embodiments, in response to the prompt area in the notification bar including one display area for the prompt identifier, the specific icon identifier may be displayed in the one display area. In response to the prompt area of the notification bar including two display areas for the prompt identifier, the specific icon identifier may be displayed in a smaller display area (e.g., the first prompt area).

In some embodiments, in response to the quantity of the unread notification messages being greater than one and less than or equal to the first threshold, an icon identifier of an application corresponding to the latest notification message in unread notification messages may also be displayed together with the specific icon identifier in the prompt area.

In some embodiments, as shown in FIG. 3D, in response to the quantity of the unread notification messages being greater than one and less than or equal to the first threshold, the icon identifier of the application corresponding to the latest notification message may be displayed while displaying the specific icon identifier. For example, the corresponding icon identifier may be the “QQ” icon identifier in response to the latest notification message being a notification message pushed by the “QQ” server. Then, the specific icon identifier and the icon identifier of the corresponding application may be displayed together in the prompt area of the notification bar. In some embodiments, the first threshold may be, for example, two. In some embodiments, in response to the quantity of unread notification messages being two and the latest notification message being from the “QQ” server, the specific icon identifier and the icon identifier of the “QQ” application may be displayed in the prompt area of the notification bar, as shown in FIG. 3D.

In some embodiments, in response to the prompt area of the notification bar including two display areas for the prompt identifier, the specific icon identifiers may be displayed in a smaller display area (e.g., the first prompt area), and the icon identifier of a corresponding application may be displayed in a larger display area (e.g., the second prompt area).

In some embodiments, in response to the quantity of the unread notification messages being greater than one and less than or equal to the first threshold, the specific icon identifier may be displayed in the prompt area of the notification bar. In some embodiments, the specific icon identifier may be displayed to notify the user with a plurality of notification messages. In other embodiments, both the specific icon identifier and the icon identifier of an application corresponding to the latest notification message may be displayed to notify the user with a plurality of unread notification messages, and which application the latest notification message came from (e.g., from “QQ”). The specific icon identifier instead of a plurality of icon identifiers of applications may occupy a smaller display area, and may also notify the user with a plurality of unread notification messages.

In S303: In response to the quantity of unread notification messages being greater than the first threshold, displaying the numeric identifier consistent with the quantity information of unread notification messages, and the numeric identifier may be prompt identifier.

In some embodiments, in response to the quantity of the unread notification messages being greater than the first threshold, there may be a plurality of unread notification messages. For example, in response to the first threshold being two, there may be at least three unread notification messages. Accordingly, the numeric identifier consistent with the quantity of the unread notification messages may be displayed, and the numeric identifier as the prompt identifier may be displayed in the prompt area of the notification bar to notify the user with currently a plurality of unread notification messages and the quantity of the unread notification messages.

In some embodiments, numbers in the numeric identifier may be, for example, Arabic numerals, Chinese numerals, or Roman numerals, etc. The form of the numeric identifier is not limited by the present disclosure, and may be determined according to various application scenarios as long as the numeric identifier can represent the quantity of unread notification messages.

In some embodiments, referring to FIG. 3E, in response to the quantity of unread notification messages being greater than the first threshold, the numeric identifier consistent with the quantity of the unread notification messages may be displayed. For example, the numeric identifier representing three may be displayed in response to the quantity of the unread notification messages being three. Then, the numeric identifier representing three as the prompt identifier may be displayed in the prompt area of the notification bar to notify the user with three unread notification messages.

In some embodiments, in response to the prompt area of the notification bar including one display area for the prompt identifier, the numeric identifier may be displayed in the one display area. In response to the prompt area of the notification bar including two display areas for the prompt identifier, the numeric identifier may be displayed in a larger display area (e.g., the second prompt area).

In some embodiments, in response to the quantity of the unread notification messages being greater than the first threshold, the specific icon identifier may also be displayed. The specific icon identifier and the numeric identifier may be displayed together in the prompt area.

In some embodiments, referring to FIG. 3F, in response to the quantity of the unread notification messages being greater than the first threshold, the specific icon identifier may be displayed while displaying the numeric identifier. For example, in response to the quantity of the unread notification messages being three, the numeric identifier representing three may be displayed and, at the same time, the specific icon identifier, e.g., two downward pointing arrows as shown in FIG. 3F, may be displayed. Then, the numeric identifier and the specific icon identifier may be displayed together in the prompt area of the notification bar. The specific icon identifier may be used to notify the user with currently a plurality of unread notification messages, and the numeric identifier may be used to notify the user with the quantity of current unread notification messages.

In some embodiments, in response to the prompt area of the notification bar including two display areas for the prompt identifier, the specific icon identifier may be displayed in a smaller display area (e.g., the first prompt area), and the numeric identifier may be displayed in a larger display area (e.g., the second prompt area).

In some embodiments, in response to the quantity of the unread notification messages being zero, no identifier may be displayed as the prompt identifier, and no prompt identifier may be displayed in the prompt area of the notification bar to notify the user that there is currently no unread notification message.

In some embodiments, in response to the quantity of the unread notification messages being greater than the first threshold, the numeric identifier may be displayed in the prompt area of the notification bar. In some embodiments, the numeric identifier may be displayed to notify the user with unread notification messages and the quantity of unread notification messages. In other embodiments, both the numeric identifier and the specific icon identifier may be displayed together to notify the user with unread notification messages and the quantity of unread notification messages. The numeric identifier instead of a plurality of icon identifiers of applications may occupy a smaller display area, and may notify the user multiple unread notification messages.

In some embodiments, prompt identifiers displayed in the prompt area of the notification bar may be different in response to a different quantity of unread notification messages. For example, in response to one unread notification message, the icon identifier of an application corresponding to the unread notification message may be displayed to notify the user that the application pushes a notification message. In response to the quantity of the unread notification messages being greater than one and less than or equal to the first threshold (e.g., two), in some embodiments, the specific icon identifier may be displayed to notify the user with a plurality of unread notification messages. In other embodiments, both the specific icon identifier and the icon identifier of an application corresponding to the latest notification message may be displayed to notify the user with a plurality of unread notification messages, and which application the latest notification message came from. In response to the quantity of the unread notification messages being greater than the first threshold, in some embodiments, the numeric identifier may be displayed to notify the user with how many unread notification messages. In other embodiments, both the numeric identifier and the specific icon identifier may be displayed to notify the user with a plurality of unread notification messages and the quantity of the unread notification messages. The display method of the prompt identifier in some embodiments may save the display area of the notification bar and may provide various prompt identifiers according to different quantity of the unread notification messages. Therefore, user experience may be improved.

FIG. 4 illustrates a flow chart of another example of a method for displaying prompt identifier based on the quantity of the unread notification messages consistent with some embodiments of the present disclosure. Referring to FIG. 4, the method for displaying the prompt identifier in the prompt area of the notification bar based on the quantity information of unread notification messages in S202 in FIG. 2 is described in detail as follows.

In S401: In response to one unread notification message, displaying an icon identifier of an application corresponding to the one unread notification message, and the icon identifier may be the prompt identifier. The process described in S401 may be the same as or similar to the process described in S301 in FIG. 3A, and is not repeated herein.

In S402: In response to the quantity of the unread notification messages being greater than one, displaying a numeric identifier consistent with the quantity information of the unread notification messages, and the numeric identifier may be the prompt identifier.

In some embodiments, in response to the quantity of the unread notification messages being greater than one, there may be a plurality of unread notification messages. Accordingly, the numeric identifier consistent with the quantity of unread notification messages may be displayed, and the numeric identifier as the prompt identifier may be displayed in the prompt area of the notification bar to notify the user with currently a plurality of unread notification messages and the quantity of unread notification messages.

In some embodiments, numbers in the numeric identifier may be, for example, Arabic numerals, Chinese numerals, or Roman numerals, etc. The form of the numeric identifier is not limited by the present disclosure, and may be determined according to various application scenarios as long as the numeric identifier can represent the quantity of the unread notification messages.

In some embodiments, in response to the prompt area of the notification bar including one display area for the prompt identifier, the numeric identifier may be displayed in the one display area. In response to the prompt area of the notification bar including two display areas for the prompt identifier, the numeric identifier may be displayed in a larger display area (e.g., the second prompt area).

In some embodiments, in response to the quantity of the unread notification messages being greater than one, the specific icon identifier may also be displayed. The specific icon identifier and the numeric identifier may be displayed together in the prompt area.

In some embodiments, in response to the quantity of the unread notification messages being greater than one, the specific icon identifier may be displayed while displaying the numeric identifier. For example, in response to the quantity of the unread notification messages being three, the numeric identifier representing three may be displayed and, at the same time, the specific icon identifier, e.g., two downward pointing arrows as shown in FIG. 3F, may be displayed. Then, the numeric identifier and the specific icon identifier may be displayed together in the prompt area of the notification bar.

In some embodiments, in response to the prompt area of the notification bar including two display areas for the prompt identifier, the specific icon identifier may be displayed in a smaller display area (e.g., the first prompt area), and the numeric identifier may be displayed in a larger display area (e.g., the second prompt area).

In some embodiments, in response to the quantity of the unread notification messages being zero, no identifier may be displayed as the prompt identifier, and no prompt identifier may be displayed in the prompt area of the notification bar to notify the user that there is currently no unread notification message.

In some embodiments, prompt identifiers displayed in the prompt area of the notification bar may be different in response to a different quantity of the unread notification messages. For example, in response to one unread notification message, the icon identifier of the application corresponding to the unread notification message may be displayed to notify the user that the application pushes a notification message. In response to the quantity of unread notification messages being greater than one, in some embodiments, the numeric identifier may be displayed to notify the user how many unread notification messages. In other embodiments, both the numeric identifier and the specific icon identifier may be displayed together to notify the user with a plurality of unread notification messages and the quantity of the unread notification messages. The display method of the prompt identifier in some embodiments may save the display area of the notification bar, and may improve user experience.

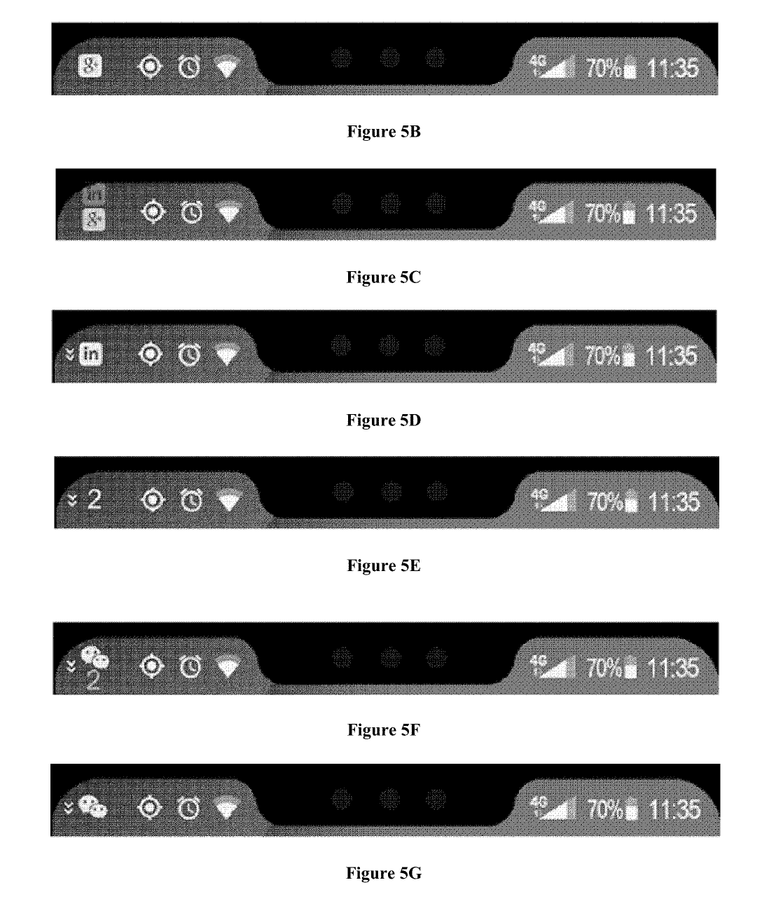

Referring to FIGS. 5A-5I, a method for updating the prompt identifier is described as follows in combination with the application scenario illustrated in FIG. 1 and the disclosed display method associated with FIGS. 2-4.

FIG. 5A illustrates an example of a method for updating the prompt identifier consistent with some embodiments of the present disclosure. Referring to FIG. 5A, the method for updating the prompt identifier may include the following.

In S501: Obtaining a new notification message after the display screen is activated.

In some embodiments, the display screen may be always activated, and the new notification message may be obtained upon the new notification message appears. In other embodiments, the new notification message may be obtained after the display screen is activated from an inactive state. For example, the new notification message may appear in response to the display screen being in the inactive state, while the new notification message may be obtained until the display screen is activated.

In S502: Determining a prompt identifier of the new notification message based on the quantity of the unread notification messages.

In some embodiments, the displayed prompt identifier may be different in response to a different quantity of the unread notification messages. Therefore, the prompt identifier of the new notification message may be related to the quantity of the unread notification messages.

For example, in response to the prompt identifier being displayed in the manner described in FIG. 3, the method for updating the prompt identifier may include but not be limited to following situations.

In some embodiments, in response to the quantity of unread notification messages being zero, an icon identifier of an application corresponding to the new notification message may be displayed in the prompt area of the notification bar.

In some embodiments, in response to the quantity of unread notification messages being zero, after obtaining the new notification message, the quantity of the unread notification messages may change to one from zero. Referring to the display method associated with S301 in FIG. 3, the icon identifier corresponding to the new notification message may be displayed in the prompt area of the notification bar. For example, the icon identifier of an application instead of no display content may be displayed in the prompt area of the notification bar, to notify the user with an unread notification message.

In response to one unread notification message, after reading the unread notification message, the quantity of the unread notification messages may change to zero from one. Then, the icon identifier of the application corresponding to the notification message may be removed from the prompt area of the notification bar.

In other embodiments, in response to the quantity of the unread notification messages being greater than zero and less than the preset threshold (e.g., the preset threshold may be two), the specific icon identifier and an icon identifier of an application corresponding to the new notification message may be obtained. The specific icon identifier and the icon identifier of the application may be used to update the display of the prompt area.

In some embodiments, in response to the quantity of unread notification messages being one (greater than zero and less than the preset threshold), after obtaining the new notification message, the quantity of current unread notification messages may change to two from one. That is, the quantity of the current unread notification messages may be greater than one and less than or equal to the preset threshold (e.g., the preset threshold may be 2). Referring to the display method associated with S302 in FIG. 3, the specific icon identifier and the icon identifier of the application corresponding to the new notification message may be displayed in the prompt area of the notification bar.

In some embodiments, in response to replacing the original prompt identifier with the specific icon identifier and the icon identifier of the application corresponding to the new notification message, a scroll display method may be employed.

FIGS. 5B-5D illustrate schematic diagrams of examples of updated prompt identifiers consistent with some embodiments of the present disclosure. Referring to FIGS. 5B-5D, in some embodiments, in response to unread notification message being a notification message pushed by a “Google” application, a “Google” icon identifier shown in FIG. 5B may be displayed in the prompt area. After obtaining a new notification message, e.g., the new notification message may come from an “in” application, the quantity of current unread notification messages may change to two, and the original “Google” icon identifier may be replaced with the specific icon identifier and the “in” icon identifier, as shown in FIGS. 5C-5D. In other words, the “in” icon identifier may scroll to replace the “Google” icon identifier, and the specific icon identifier and the “in” icon identifier may be simultaneously displayed in the prompt area, as shown in FIG. 5D.

In response to the quantity of the unread notification messages being two, after reading one of unread notification messages, the quantity of the unread notification messages may change to one from two. Accordingly, the specific icon identifier in the prompt area of the notification bar may be removed, and the display content of the area for displaying the icon identifier of an application may be replaced with the icon identifier of the application corresponding to unread notification message.

In other embodiments, in response to the quantity of the unread notification messages being greater than or equal to the preset threshold (e.g., the preset threshold may be two), a quantity value of the unread notification messages may be obtained, and a numeric identifier consistent with the quantity value incremented by one may be displayed. The numeric identifier may be used to update the display in the prompt area.

In some embodiments, in response to the quantity of the unread notification messages being two, after obtaining the new notification message, the quantity of current unread notification messages may change to three from two. That is, the quantity of the current unread notification messages may be greater than the preset threshold (e.g., the preset threshold may be two). Accordingly, referring to the display method associated with S303 in FIG. 3, the corresponding numeric identifier may be displayed in the prompt area of the notification bar.

For example, in response to the quantity of unread notification messages being two, after obtaining the new notification message, the numeric identifier representing three may be displayed in the prompt area of the notification bar.

In some embodiments, the icon identifier of the application corresponding to the new notification message may be displayed first, and then the corresponding numeric identifier may be displayed.

For example, as shown in FIGS. 5E-5I, in response to the quantity of the unread notification messages being two, as shown in FIG. 5E, a numeric identifier representing two and the specific icon identifier may be displayed in the prompt area of the notification bar. After obtaining the new notification message, e.g., the new notification message may come from the “WeChat” application, the quantity of current unread notification messages may change to three, and the numeric identifier representing two may be replaced with the numeric identifier representing three, as shown in FIGS. 5F-5I. In other words, the “WeChat” icon identifier may first scroll to replace the numeric identifier representing two (e.g., as shown in FIGS. 5F-5G) to notify the user that the new notification message is a notification message from the “WeChat” server. Then, the numeric identifier representing three may scroll to replace the “WeChat” icon identifier (e.g., as shown in FIGS. 5H-5I) to notify the user that there are three unread notification messages.

In response to the quantity of the unread notification messages being three, after reading one unread notification message, the quantity of the unread notification messages may change to two from three. Then, the numeric identifier in the prompt area of the notification bay may be replaced with the icon identifier of the application corresponding to the latest unread notification message, and the specific icon identifier may be retained.

In some embodiments, in response to the quantity of the unread notification messages being greater than one, updating the display of the prompt area of the notification bar with the prompt identifier of the new notification message may include the following. The display of the specific icon identifier in the prompt area may be maintained unchanged, and the numeric identifier previously displayed in the prompt area may be replaced with another numeric identifier consistent with the quantity value of the unread notification messages incremented by one. For example, in response to the numeric identifier representing three and the specific icon identifier previously being displayed in the prompt area, after obtaining the new notification message, the numeric identifier may be replaced with another numeric identifier representing four, and the specific icon identifier may not be changed.

For example, in response to the prompt identifier being displayed in the manner associated with FIG. 4, the method for updating the prompt identifier may include but not be limited to following situations.

In some embodiments, in response to the quantity of the unread notification messages being zero, an icon identifier of an application corresponding to the new notification message may be displayed in the prompt area of the notification bar.

In some embodiments, in response to the quantity of the unread notification messages being zero, after obtaining the new notification message, the quantity of current unread notification messages may change to one from zero. Referring to the display method associated with S401 in FIG. 4, the icon identifier corresponding to the new notification message may be displayed in the prompt area of the notification bar.

In other embodiments, in response to the quantity of the unread notification messages being greater than or equal to one, a quantity value of unread notification messages may be obtained, and a numeric identifier consistent with the quantity value incremented by one may be displayed. The numeric identifier may be used to update the display in the prompt area. In some embodiments, the specific icon identifier may be displayed in the prompt area of the notification bar while displaying the numeric identifier.

In some embodiments, in response to the quantity of the unread notification messages being greater than or equal to one, after obtaining the new notification message, the quantity of current unread notification messages may be greater than one. Accordingly, referring to the display method associated with S402 in FIG. 4, the corresponding numeric identifier may be displayed in the prompt area of the notification bar. For example, in response to one unread notification message, after obtaining the new notification message, the numeric identifier representing two may be displayed in the prompt area of the notification bar. That is, the numeric identifier representing two instead of the icon identifier of an application may be displayed in the prompt area of the notification bar to notify the user with two unread notification messages. In some embodiments, the specific icon identifier may be displayed in the prompt area of the notification bar while displaying the numeric identifier representing two.

In some embodiments, the icon identifier of the application corresponding to the new notification message may be displayed first, and then the corresponding numeric identifier may be displayed.

For example, as shown in FIGS. 5E-5I, in response to the quantity of the unread notification messages being two, as shown in FIG. 5E, the numeric identifier representing two and the specific icon identifier may be displayed in the prompt area of the notification bar. After obtaining the new notification message, e.g., the new notification message may come from the “WeChat” application, the quantity of current unread notification messages may change to three, and the numeric identifier representing two may be replaced with the numeric identifier representing three, as shown in FIGS. 5F-5I. In other words, the “WeChat” icon identifier may first scroll to replace the numeric identifier representing two (e.g., as shown in FIGS. 5F-5G) to notify the user that the new notification message is a notification message from the “WeChat” server. Then, the numeric identifier representing three may scroll to replace the “WeChat” icon identifier (e.g., as shown in FIGS. 5H-5I) to notify the user with three unread notification messages.

In response to the quantity of the unread notification messages being two, after reading one unread notification message, the quantity of the unread notification messages may change to one from two. Then, the specific icon identifier in the prompt area of the notification bar may be removed, and the display content of the area for displaying the numeric identifier may be replaced with the icon identifier of the application corresponding to the unread notification message.

In S503: Updating the display of the prompt area of the notification bar with the prompt identifier of the new notification message.

In some embodiments, after determining the prompt identifier of the new notification message, the original prompt identifier in the prompt area may be replaced with the prompt identifier of the new notification message.

In some embodiments, during replacing the original prompt identifier with the new prompt identifier, the icon identifier of the application corresponding to the new notification message may be displayed to prompt the user which application the new notification message came from.

In some embodiments, after receiving the new notification message, the display contents of the prompt area of the notification bar may be updated in real time. Therefore, the status of the latest notification message may be displayed in real time, and the user experience may be improved. In addition, in the disclosed process of updating the display contents of the prompt area, the icon identifier of the application corresponding to the new notification message may be displayed to prompt the user which application the new notification message came from.

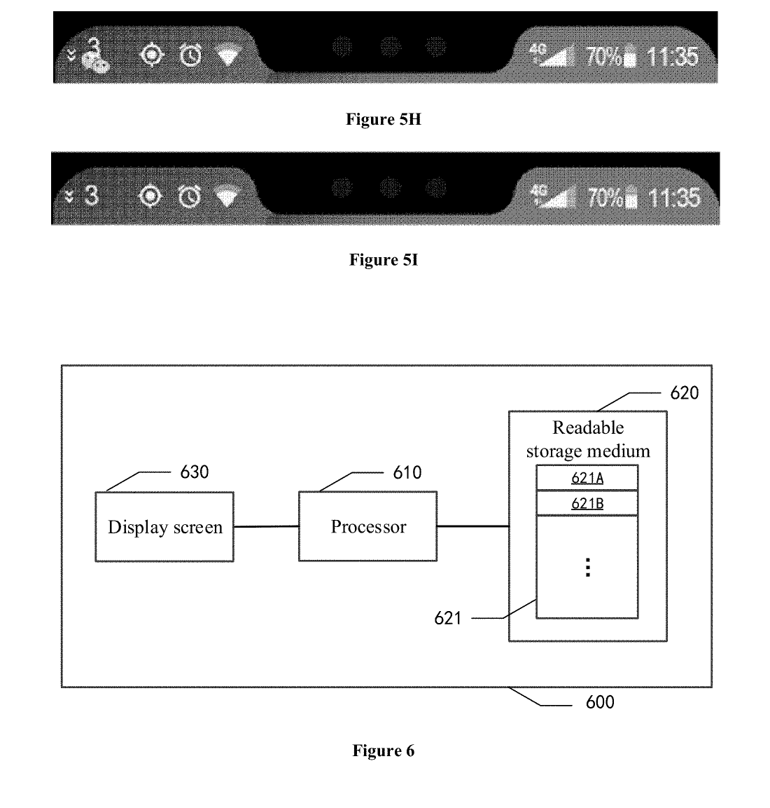

The present disclosure also provides an electronic device. FIG. 6 illustrates a schematic diagram of an example of an electronic device consistent with some embodiments of the present disclosure. Referring to FIG. 6, the electronic device 600 may include a processor 610, a computer-readable storage medium 620, and a display screen 630. The electronic device 600 may execute the methods described in various embodiments associated with FIGS. 2-5, to realize the display of the prompt identifier.

In some embodiments, the processor 610 may include a general-purpose microprocessor, an instruction set processor and/or associated chipsets, and/or a special purpose microprocessor (e.g., an application specific integrated circuit (ASIC)), etc. The processor 610 may also include an on-board memory for caching purpose. The processor 610 may be a single processing unit or multiple processing units for executing different actions of the disclosed methods associated with FIGS. 2-5.

The computer-readable storage medium 620 may be any medium that can contain, store, communicate, propagate, or transmit the instructions. For example, the readable storage medium may include but is not limited to electrical, magnetic, optical, electromagnetic, infrared, or semiconducting system, apparatus, device, or propagating medium. In some embodiments, the readable storage medium may include a magnetic storage device, such as a magnetic tape or a hard disk (HDD); an optical storage device, such as a compact disk (CD-ROM); a memory, such as a random access memory (RAM) or a flash memory; and/or wire/wireless communication link.

The computer-readable storage medium 620 may include a computer program 621. The computer program 621 may include codes/computer-executable instructions, such that to execute the computer program 621, the processor 610 may execute the above disclosed methods and any variations thereof associated with FIGS. 2-5.

In some embodiments, the computer program 621 may be configured with computer program code including a computer program unit. For example, in some embodiments, the code in the computer program 621 may include one or more program units including a unit 621A, a unit 621B, . . . . The division manner and the quantity of the units are not fixed, and those skilled in the art may use suitable program units or a combination of program units according to actual conditions. To execute the combination of the program units, the processor 610 may execute the above disclosed methods and any variations thereof associated with FIGS. 2-5.

The display screen 630 may be used to display a notification bar, and to display different prompt identifiers in a corresponding prompt area of the notification bar.

In some embodiments, a non-transitory computer-readable storage medium may be provided. The non-transitory computer-readable storage medium may have computer-executable instructions stored thereon. When being executed, the computer-executable instructions may cause the processor to perform the display method. The method may include obtaining quantity information of unread notification messages received by the electronic device. The method may also include displaying a prompt identifier in a prompt area of the notification bar of the display screen of the electronic device based on the quantity information of the unread notification messages. The prompt identifier displayed in the prompt area of the notification bar may be different in response to a different quantity of the unread notification messages.

The description of some embodiments is provided to illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A display method, comprising:
obtaining quantity information of unread notification messages received by an electronic device; and
displaying a prompt identifier in a prompt area of a notification bar of a display screen of the electronic device based on the quantity information of the unread notification messages,
wherein the prompt identifier displayed in the prompt area of the notification bar is different in response to a different quantity of the unread notification messages.

2. The method according to claim 1, wherein displaying the prompt identifier in the prompt area of the notification bar based on the quantity information of the unread notification messages includes:
in response to one unread notification message, displaying an icon identifier of an application corresponding to the one unread notification message, wherein the icon identifier is the prompt identifier; and
in response to a quantity of the unread notification messages being greater than one and less than or equal to a first threshold, displaying a specific icon identifier for indicating a plurality of unread notification messages, wherein the specific icon identifier is the prompt identifier.

3. The method according to claim 2, further including:
in response to the quantity of the unread notification messages being greater than one and less than or equal to the first threshold, displaying an icon identifier of an application corresponding to a latest notification message in the unread notification messages, wherein the icon identifier of the application corresponds to the latest notification message and the specific icon identifier together in the prompt area.

4. The method according to claim 2, wherein displaying the prompt identifier in the prompt area of the notification bar based on the quantity information of the unread notification messages further includes:
in response to the quantity of the unread notification messages being greater than the first threshold, displaying a numeric identifier consistent with the quantity information of the unread notification messages, wherein the numeric identifier is the prompt identifier.

5. The method according to claim 4, further including:
in response to the quantity of the unread notification messages being greater than the first threshold, displaying the specific icon identifier and the numeric identifier together in the prompt area.

6. The method according to claim 1, wherein displaying the prompt identifier in the prompt area of the notification bar based on the quantity information of the unread notification messages includes:
in response to one unread notification message, displaying an icon identifier of an application corresponding to the one unread notification message, wherein the icon identifier is the prompt identifier; and
in response to a quantity of the unread notification messages being greater than one, displaying a numeric identifier consistent with the quantity information of the unread notification messages, wherein the numeric identifier is the prompt identifier.

7. The method according to claim 6, further including:
in response to the quantity of the unread notification messages being greater than one, displaying a specific icon identifier and the numeric identifier together in the prompt area.

8. The method according to claim 1,wherein the quantity information of unread notification messages is obtained in response to the display screen of the electronic device being activated, the method further comprises:
obtaining a new notification message after the display screen is activated;
determining the prompt identifier of the new notification message based on a quantity of the unread notification messages; and
updating a display of the prompt area of the notification bar with the prompt identifier of the new notification message.

9. The method according to claim 8, wherein determining the prompt identifier of the new notification message based on the quantity of the unread notification messages includes:
in response to the quantity of the unread notification messages being zero, displaying an icon identifier of an application corresponding to the new notification message in the prompt area of the notification bar;
in response to one unread notification message, updating the display of the prompt area with a specific icon identifier and the icon identifier of the application corresponding to the new notification message; and
in response to the quantity of the unread notification messages being greater than one, obtaining a quantity value of the unread notification messages and a numeric identifier consistent with the quantity value incremented by one, and updating the display of the prompt area with the numeric identifier.

10. The method according to claim 9, wherein updating the display of the prompt area of the notification bar with the prompt identifier of the new notification message includes:
in response to the quantity of the unread notification messages being greater than one, maintaining the display of the specific icon identifier in the prompt area unchanged, and
replacing the numeric identifier previously displayed in the prompt area with another numeric identifier consistent with the quantity value of the unread notification messages incremented by one.

11. The method according to claim 1, wherein:
the prompt area of the notification bar displays one or two prompt identifiers.

12. An electronic device, comprising:
a display screen; and
a processor, coupled with the display screen, wherein the processor is configured to:
obtain quantity information of unread notification messages received by the electronic device, and
display a prompt identifier in a prompt area of the notification bar of the display screen based on the quantity information of the unread notification messages,
wherein the prompt identifier displayed in the prompt area of the notification bar of the display screen is different in response to a different quantity of the unread notification messages.

13. The electronic device according to claim 12, wherein the processor is configured:
in response to one unread notification message received by the electronic device, to display an icon identifier of an application corresponding to the one unread notification message, wherein the icon identifier is the prompt identifier; and
in response to a quantity of the unread notification messages being greater than one and less than or equal to a first threshold, to display a specific icon identifier for indicating a plurality of unread notification messages, wherein the specific icon identifier is the prompt identifier.

14. The electronic device according to claim 13, wherein the processor is further configured:
in response to the quantity of the unread notification messages being greater than the first threshold, to display a numeric identifier consistent with the quantity information of the unread notification messages, wherein the numeric identifier is the prompt identifier.

15. The electronic device according to claim 12, wherein the processor is further configured:
in response to one unread notification message, to display an icon identifier of an application corresponding to the one unread notification message, wherein the icon identifier is the prompt identifier; and
in response to a quantity of the unread notification messages being greater than one, to display a numeric identifier consistent with the quantity information of the unread notification messages, wherein the numeric identifier is the prompt identifier.

16. The electronic device according to claim 12, wherein the processor is further configured to:
obtain a new notification message in response to the display screen being activated;
determine the prompt identifier of the new notification message based on a quantity of the unread notification messages; and
updates a display of the prompt area of the notification bar with the prompt identifier of the new notification message.

17. The method according to claim 16, wherein the processor is further configured:
in response to the quantity of the unread notification messages being zero, to display an icon identifier of an application corresponding to the new notification message in the prompt area;
in response to one unread notification message, to update the display of the prompt area with a specific icon identifier and the icon identifier of the application corresponding to the new notification message; and
in response to the quantity of the unread notification messages being greater than one, to obtain a quantity value of the unread notification messages and a numeric identifier consistent with the quantity value incremented by one, and updates the display of the prompt area with the numeric identifier.

18. The electronic device according to claim 17, wherein the processor is further configured:
in response to the quantity of the unread notification messages being greater than one, to maintain the display of the specific icon identifier in the prompt area unchanged, and
replaces the numeric identifier previously displayed in the prompt area with another numeric identifier consistent with the quantity value of the unread notification messages incremented by one.

19. The electronic device according to claim 12, wherein:
the prompt area of the notification bar is configured to display one or two prompt identifiers.

20. A non-transitory computer-readable storage medium, having computer-executable instructions stored thereon, wherein when being executed, the computer-executable instructions cause a processor to perform a display method, the method comprising:
obtaining quantity information of unread notification messages received by an electronic device; and
displaying a prompt identifier in a prompt area of a notification bar of a display screen of the electronic device based on the quantity information of the unread notification messages,
wherein the prompt identifier displayed in the prompt area of the notification bar is different in response to a different quantity of the unread notification messages.
